(19) United States
(12) Patent Application Publication
(10) Pub. No.: US 2022/0233893 A1
(43) Pub. Date: Jul. 28, 2022

(54) APPARATUS FOR CONNECTING A FACE MASK TO AN AIR HOSE

(71) Applicant: VENTUS RESPIRATORY TECHNOLOGIES INC., Kitchener (CA)

(72) Inventors: Peter Lionel WHITBY, Waterloo (CA); Richard Devin SZASZ, Waterloo (CA); Norrie Tienlor SHENG, Waterloo (CA)

(21) Appl. No.: 17/617,243

(22) PCT Filed: Jun. 5, 2020
(86) PCT No.: PCT/CA2020/050774

§ 371 Date: Dec. 7, 2021

Related U.S. Application Data
(60) Provisional application No. 62/858,596, filed on Jun. 7, 2019.

(51) Int. Cl. A62B 9/04; A62B 9/02; A62B 23/02; A62B 21/00

(52) U.S. Cl. CPC A62B 9/04; A62B 21/00; A62B 23/025; A62B 9/02

(57) ABSTRACT

A respiratory system composes an oxygen supply, a vented respiratory mask, a hose coupled to the oxygen supply, and a connector apparatus joining the respiratory mask and the hose. The connector apparatus may comprise mask connector member to govern fluid flow through a vent in a mask, a mask valve received in a mask fluid flow passage movable between a rest position in which the mask fluid flow passage is blocked and an actuated position in which the mask fluid flow passage is unblocked, a biasing member biasing the mask valve towards the rest position, and a hose connector member to be secured to a fluid hose. The hose connector member includes a valve actuator to move the mask valve to the actuated position when the hose connector member is coupled to the mask connector member.

### TECHNICAL FIELD

The disclosure relates to face masks, and in particular to apparatus for connecting a face mask to an air hose.

### BACKGROUND

Respiratory masks are used in a wide variety of applications to protect a respiratory system from particles suspended in the air or from unpleasant or noxious gases. Such masks include filter masks which are commonly worn by persons who are in polluted environments in an effort to protect themselves from inhaling airborne contaminants. Filter masks typically have a fibrous or sorbent filter that is capable of removing particulate and/or gaseous contaminants from the air.

An example of a filter mask is disclosed in Patent Application Publication WO 2018/045456 filed by the present Applicant. The filter mask includes a face seal for providing an airtight flexible seal around the nose and mouth of a user, a support sealably attached to the face seal, wherein the support has an open area that allows for passage of incoming air and outlet valves for expelling exhaled air, a front shell for removably attaching to the support, wherein the front shell has inlet holes for allowing the incoming air to pass through the open area of the support, and a filter for filtering particulate elements from air. The filter is configured to be housed between the front shell and the support. The face seal provides a direct connection between the filter and the user.

Filter masks are often provided for use in environments in which ambient air is contaminated. However, in some circumstances face masks are needed for use in an environment in which ambient air is both contaminated and deficient in desired constituents. For example, it may be desirable to use a face mask with an auxiliary oxygen supply.

### SUMMARY

In a first aspect, some embodiments of the invention provide a connector apparatus, comprising a mask connector member to be secured to a mask to govern fluid flow through a vent in the mask, the mask connector member form mg a mask fluid flow passage through the vent between an external inlet and an internal outlet, the mask connector member including a mask valve received in the mask fluid flow passage, the mask valve movable between a rest position in which the mask fluid flow passage is blocked by the mask valve and an actuated position in which the mask fluid flow passage is unblocked by the mask valve, the mask connector member further including a biasing member biasing the mask valve towards the rest position; and a hose connector member to be secured to a fluid hose, the hose connector member forming a hose fluid flow passage between a hose inlet and a mask outlet, the hose inlet shaped to receive a fluid flow from the fluid hose when the fluid hose is secured to the hose connector member, the mask outlet shaped to form a sealed connection with the external inlet of the mask connector member to supply the fluid flow to the external inlet of the mask connector member when the hose connector member is coupled to the mask connector member, the hose connector member including a valve actuator to move the mask valve to the actuated position when the hose connector member is coupled to the mask connector member.

In some embodiments, the mask valve includes a first magnetic element and the valve actuator includes a second magnetic element configured to attract the first magnetic element to draw the mask valve from the rest position to the actuated position.

The mask connector may include an inner assembly to seal against an inner surface of the face mask around an inner periphery of the vent; and an outer assembly to seal against an outer surface of the face mask around an outer periphery of the vent, the inner assembly and the outer assembly releasably connectable through the vent to form the mask fluid flow passage through the vent.

The second magnetic element may be secured to a hose valve, the hose valve received in the hose fluid flow passage and movable between a rest position in which the hose fluid flow passage is blocked by the hose valve and an actuated position in which the hose fluid flow passage is unblocked by the hose valve, the hose valve configured to be drawn toward the actuated position when adjacent the mask valve by the first magnetic element.

The mask connector member may include a first mechanical coupling element and the hose connector member includes a second mechanical coupling element, the first and second mechanical coupling elements configured to releaseably couple the hose connector member to the mask connector member.

The hose fluid flow passage may be a non-linear passage.

The mask valve may be a disc valve.

The biasing member may be a compression spring.

In a second aspect, some embodiments of the invention provide a respiratory system, comprising an oxygen supply; a respiratory mask having a vent therethrough; a mask connector member secured to the respiratory mask to govern fluid flow through the vent, the mask connector member having a valve moveable between a rest position blocking fluid flow through the vent and an actuated position unblocking fluid flow through the vent, the valve biased towards the rest position; a hose having first and second ends and coupled to the oxygen supply at the first end to receive the flow of air from the oxygen supply; and a hose connector member coupled to the hose at the second end to receive the flow of air from the hose, the hose connector member shaped to be coupled to the mask connector member to drive the valve to the actuated position and to supply the fluid flow to pass through the vent.

In some embodiments, the mask includes an exhalation opening governed by a one-way valve.

The mask may be a filter mask to allow a user to breath filtered air through the mask when the hose connector member is not coupled to the mask connector member.

The oxygen supply may be an oxygen concentrator.

### BRIEF DESCRIPTION OF THE DRAWINGS

The drawings included herewith are for illustrating various examples of systems methods, and apparatus of the present specification. In the drawings:

FIG. 1 is an exploded perspective view of a prior art face mask;

FIG. 2 is a perspective view of a connector apparatus shown deployed on a face mask;

FIG. 3 is a front perspective exploded view of a connector apparatus, according to an embodiment;

FIG. 4A is a rear perspective view of the connector apparatus of FIG. 3, with a mask connector member and a hose connector member uncoupled;

FIG. 4B is a front perspective view of the connector apparatus cf FIG. 3;

FIG. 5A is a front perspective view of the connector apparatus of FIG 3. with the mask connector member secured to a mask substructure;

FIG. 5B is a bottom elevation view of the connector apparatus and mask substructure of FIG 5A;

FIG. 6A is a rear perspective view of the mask connector member of the connector apparatus of FIG. 3 disassembled and arranged near a vent of a mask substructure.

FIG. 6B is a front perspective view of the mask connector member of FIG. 6A;

FIG. 6C is a left side elevation view of the mask connector member of FIG. 6A;

FIG. 6D is a bottom plan view of the mask connector member of FIG 6A;

FIG. 7A is a rear exploded view of the mask connector member of the connector apparatus of FIG 3;

FIG. 7B is a front exploded view of the mask connector member of FIG. 7A

FIG. 8A is a front exploded view of the hose connector member of the connector apparatus of FIG 3;

FIG. 8B is a rear exploded view of the hose connector member of FIG. 8A;

FIG. 9A is a left side plan view of the connector apparatus of FIG. 3, mounted on a mask substructure and with the mask connector member coupled to the hose connector member;

FIG. 9B is a cross sectional view of the connector apparatus of FIG. 9A without the mask substructure taken along the line 9B-9B;

FIG. 9C is a front elevation view of the connector apparatus of FIG. 9A without the mask substructure;

FIG. 9D is a right side plan view of the connector apparatus of FIG. 9A without the mask substructure;

FIG. 9E is a top plan view of the connector apparatus of FIG. 9A without the mask substructure;

FIG. 9F is a cross sectional view of the connector apparatus of FIG. 9E without the mask substructure, taken along the lines 9F-9F;

FIG. 9G is a bottom plan view of the connector apparatus of FIG. 9A without the mask substructure;

FIG. 9H is a cross sectional view of the connector apparatus of FIG. 9E without the mask substructure, taken along the line 9H-9H;

FIG. 10A is a left side plan view of the connector apparatus of FIG. 3, with the mask connector member coupled to the hose connector member and the valves in blocking positions;

FIG. 10B is a cross sectional view of the connector apparatus of FIG. 10A taken along the line 10B-10B;

FIG. 10C is a right side plan view of the connector apparatus of FIG. 3, with the mask connector member coupled to the hose connector member and the valves in actuated positions;

FIG. 10D is a cross sectional view of the connector apparatus of FIG. 10C taken along the line 10D-10D;

FIG. 11A is a side elevation view of a mask connector member, according to an embodiment;

FIG. 11B is a top plan view cf the mask connector member of FIG. 11A;

FIG. 11C is a cross section view of the mask connector member of FIG. 11A taken along the line 11C-11C of FIG. 11B;

FIG. 11D is a side elevation exploded view of the mask connector member of FIG. 11A;

FIG. 11E is a top perspective exploded view of the mask connector member of FIG. 11A;

FIG. 11F is a bottom perspective exploded view of the mask connector member of FIG. 11A;

FIG. 12A is a top perspective view of a hose connector member, according to an embodiment;

FIG. 12B is a side elevation view of the hose connector member of FIG. 12A;

FIG. 12C is a front side elevation view of the hose connector member of FIG. 12A;

FIG. 12D is a bottom plan view of the hose connector member of FIG 12A; and

FIG. 12E is a cross sectional view of the hose connector member of FIG. 12A taken along the line 12E-12E of FIG. 12D.

### DETAILED DESCRIPTION

Various apparatus or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

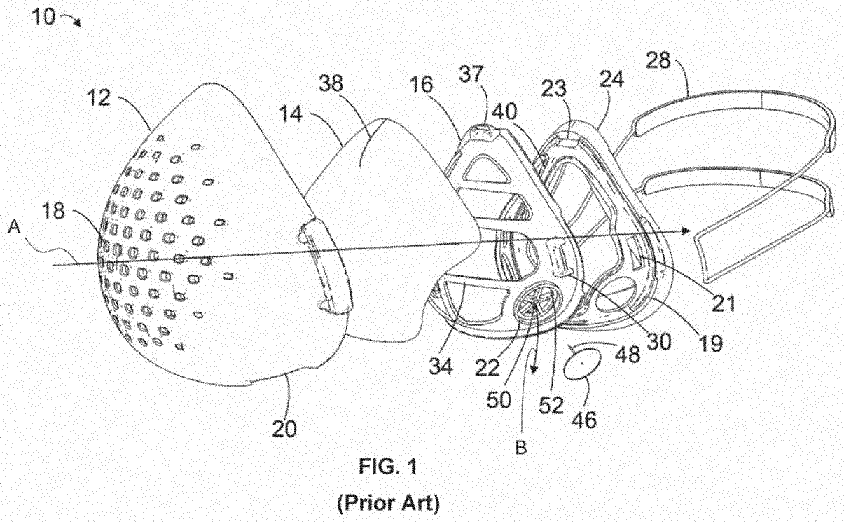

Referring to FIG. 1, illustrated therein is a face mask 10 for filtering air. Face mask 10 is disclosed in Patent Application Publication WO 2018/045456; which is hereby incorporated by reference in its entirety. Face mask 10 is a respiratory mask for filtering pollutants and particulate based airborne contaminants from the air when positioned over the face of a user. Air is drawn in by the user's breath and pollutants are filtered out and prevented from entering the respiratory system of the user. As the user exhales, the face mask 10 expels the exhaled air.

The face mask 10 includes a front shell 12 that acts as an outer layer of the face mask 10 and provides a protective outer surface. The front shell 12 attaches to a support 16 and the front shell 12 and the support 16 work together to hold a filter 14 therebetween. The face mask 10 may include a head strap 28 attached to the front shell 12 for holding the face mask 10 to a user's head. The front shell 12 has inlet holes 18 for allowing incoming air to pass in to the face mask 10 and through to the filter 14, where the filter 14 filters particulate elements from the air. The face mask 10 includes a face seal 24 attached to the periphery of the support 16 for providing a flexible and air-tight seal around the nose and mouth of the user. The face seal 24 is located behind the front shell 12 and contacts the users face to make an air tight seal against the skin. This forces all of the air intake through the front shell 12 and through the filter 14.

The filter 14 may be generally symmetrical about a center axis. When the filter 14 is folded together for use, the nose portions 38, separated by a central nose slit, mate together to form the three dimensional form for insertion into the face mask 10. The nose portions 38 align with the nose seal 40 of the face seal 24 on the framework 34 of the support 16. The perimeter of the filter 14 seals with the face seal 24.

The face seal 24 has a mating surface 19 that seals against a peripheral surface 17 of the front shell 12. The face seal 24 has attachment apertures 21 for providing access and sealing around the inner attachment members 30. Similarly, the face seal 24 also has a top aperture 23 for providing access and sealing around the upper attachment 37.

The front shell 12 also has exhale ports 20 separate from the inlet holes 18, which allow exhaled air to pass out of face mask 10. The exhale ports 20 allow exhaled air to outlet the face mask 10 so that the exhaled air does not have to pass back through the inlet holes 18 thereby degrading the filter 14 from the inside. The exhale ports 20 exit downward and away from the mouth and nose of the user. This may advantageously direct exhaled air away from the face mask 10 and reduce fogging where the user is also wearing eyeglasses.

The exhale ports 20 are in fluid communication with outlet valves 22 on the support 16. The outlet valves 22 are one-way valves and only allow for the exhaling of air from the inside of the face mask 10 and exit to the environment. The outlet valves 22 are one-way in that they do not allow air to pass from the outside of the face mask 10 in to the respiratory system of the user.

The support 16 has exit valves 46 that lead to the exhale ports 20 on the front shell 12. The exit valve 46 is a one-way valve that has a shaft 48 that passes through a hole 50 on the support 16. The exit valve 46 rests on a seat 52 of the support 16 to prevent air from passing inward. An inhalation air pathway is indicated by arrow A, while an exhalation air pathway is indicated by arrow B.

Referring now to FIG. 2, a face mask, such as face mask 10, may be adapted to be connected to an oxygen supply by the use of a connector apparatus 100 of the present disclosure. In oxygen supply system 80 of FIG. 2, face mask 10 is connected to air hose 60 drawing from an oxygen supply (not shown). The oxygen supply may be, for example, an oxygen tank or an oxygen concentrator. Filter mask substructure 400 is connected to air hose 60 by connector apparatus 100. Connector apparatus 100 includes a mask connector member 200 and a hose connector member 300.

Filter mask substructure 400 may be, for example, similar to support 16 of face mask 10. For example, filter mask substructure 400 may be used in creating a mask along with a front shell and a filter in the way that support 16 may be used in creating mask 10 along with front shell 12 and filter 14. Although a front shell and filter for use with filter mask substructure 400 may include an opening or cutout on a tower right side to permit mask connector member 200 to be mounted to filter mask substructure 400 and to permit hose connector member 300 to be connected to mask connector member 200. In some embodiments, an opening or cutout may be on a lower left side in addition or in alternative to on a lower right side to permit a connector apparatus 100 to be joined to a left side vent.

Connector apparatus 100 is configured to connect air hose 60 to one of the exhale openings of mask 10. For example, connector apparatus 100 may be configured to be coupled to a seat 52 of support 16 in place of a valve 46.

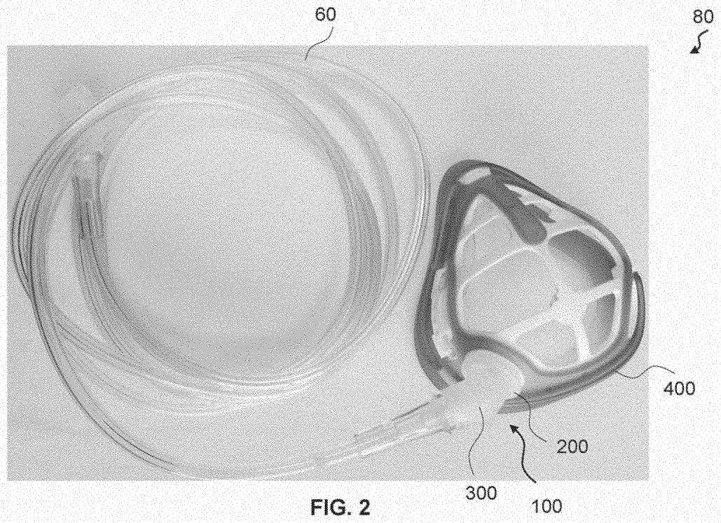

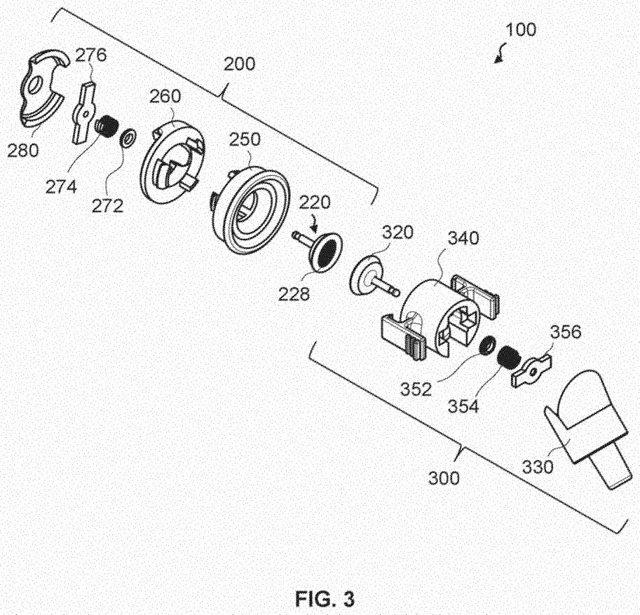

Referring to FIG. 3, an example connector apparatus 100 is shown in an exploded view. Mask connector member 200 includes a mask valve 220, an outer bracket 250, an inner bracket 260, a spring base plate 272, a helical spring 274, a valve guide plate 276, and a bracket cover 280. Hose connector member 300 includes a hose valve 320, a housing 340, a spring base plate 352, a helical compression spring 354, a valve guide plate 356, and a hose connection elbow 330.

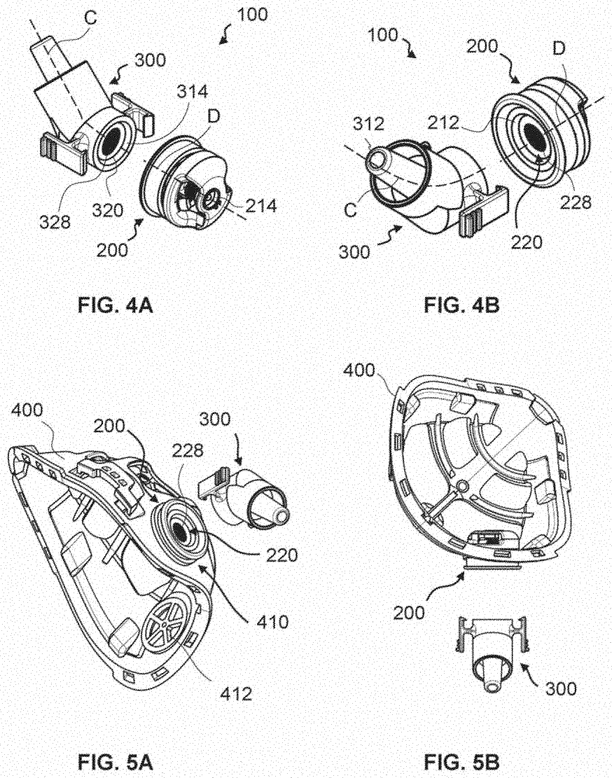

Referring to FIGS. 4A and 4B, mask connector member 200 and hose connector member 300 are shown assembled. Mask connector member 200 forms a mask fluid flow passage D from an external inlet 212 to an internal outlet 214. Hose connector member 300 forms a hose fluid flow passage C between a hose inlet 312 and a mask outlet 314. Mask connector member 200 and hose connector member 300 are shaped to be coupled to one another to form a sealed connection between mask outlet 314 and external inlet 212 to allow a fluid flow to pass from hose inlet 312 to internal outlet 214 through connector apparatus 100.

Each of mask valve 220 and hose valve 320 have a blocking member shaped to block the passage therethrough. Mask valve 220 is moveable between a rest position in which passage D is blocked by a blocking member of mask valve 220 and an actuated position in which passage D is unblocked by the blocking member. Similarly, hose valve 320 is moveable between a rest position in which passage C is blocked by a blocking member of hose valve 320 and an actuated position in which passage C is unblocked by the blocking member.

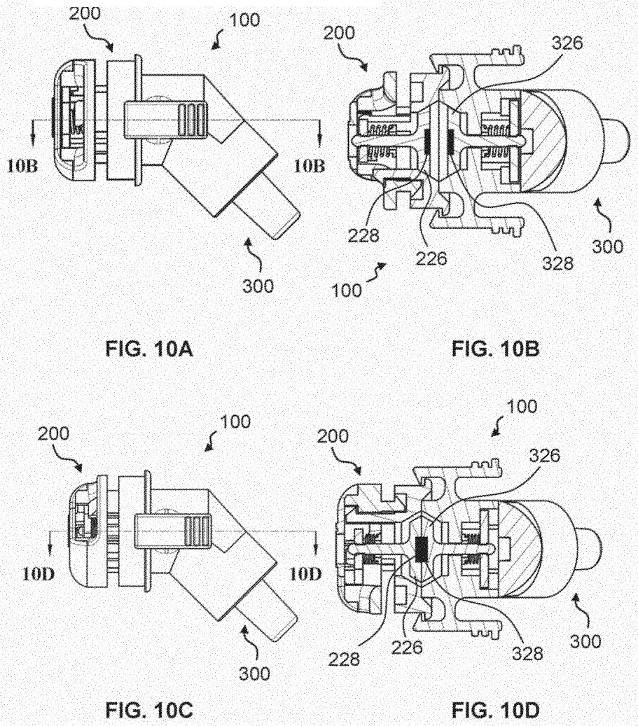

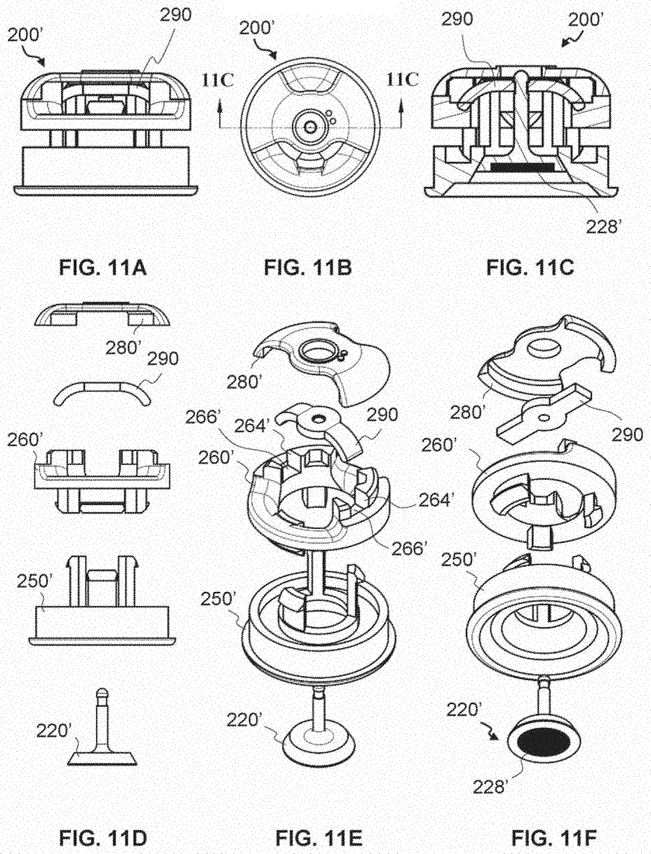

As will be described further below with reference to FIGS. 10A to 10D, connector apparatus 100 is configured so that valves 220 and 320 are in rest positions when mask connector member 200 and hose connector member 300 are removed from one another, but are in actuated positions when mask connector member 200 and hose connector member 300 are coupled to one another.

Referring to FIGS. 5A and 5B, connector apparatus 100 is shown with mask connector member 200 mounted on an example filter mask substructure 400 to govern fluid flow through vent 410 of filter mask substructure 400. As described above, filter mask substructure 400 may be similar to support 16 of face mask 10. The filter mask substructure 400 is shaped to support a filter cover to form a filter mask, allowing a user to breathe through the filter cover when mask valve 220 blocks mask connector member 200 blocking vent 410.

Mask connector member 200 is configured to govern the flow of fluid, such as oxygen enriched air, through a vent 410 in a mask formed of substructure 400, while hose connector member 300 is configured to govern the flow of fluid out of a hose (not shown) provided to supply a fluid flow to the mask. For example, a hose may be a respiratory hose supplying an oxygen enriched air flow. Mask substructure 400 also includes a second vent 412, which may be used, for example, as an exhalation vent governed by a one-way valve.

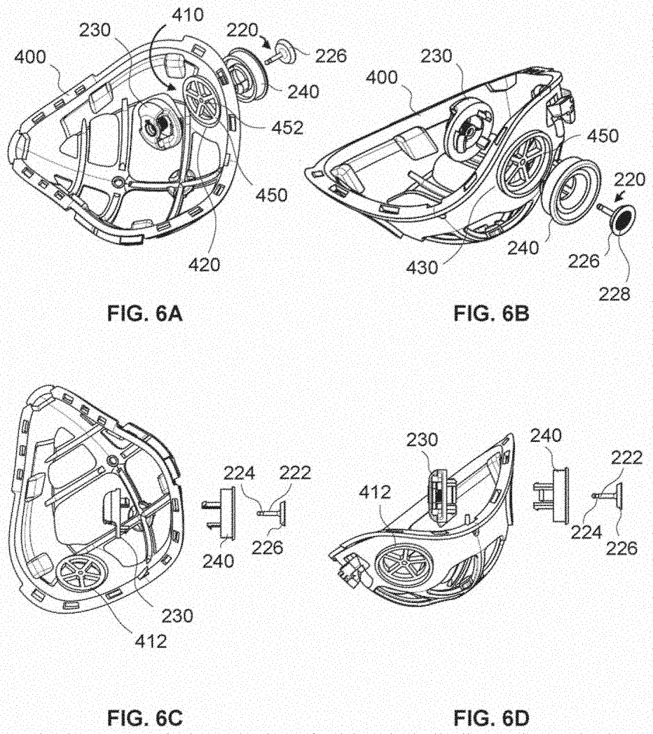

Referring to FIGS. 6A to 6D, mask connector member 200 is shown disassembled and arranged near vent 410. Vent 410 is supported by vent framing 450. Vent framing 450 includes a plurality of spokes joined at a center support 452.

Mask connector member 200 includes mask valve 220 which has a blocking member 226, and a shaft 222 having an annular groove 224. Mask connector 200 also includes an inner assembly 230 and an outer assembly 240. Inner assembly 230 is shaped to seal against an inner surface 420 of mask substructure 400 to limit fluid flow out of vent 410 to fluid flow through mask fluid flow passage D. Outer assembly 240 is shaped to seal against an outer surface 430 of mask substructure 400 to limit fluid flow into vent 410 to fluid flow through hose fluid flow passage C.

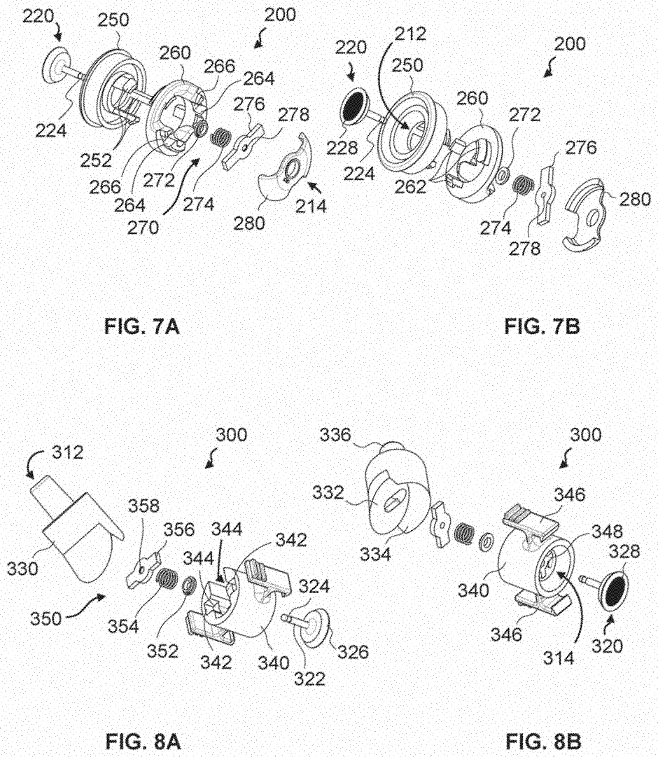

Referring to FIGS. 7A and 7B, inner and outer assemblies 230 and 240 are shown in exploded views. Inner and outer assemblies 230 and 240 can be joined to one another by passing snap-fit projections 252 and 262 through vent 410. Snap-fit projections 262 can be pushed through vent 410 and interlocked with corresponding structural supports on valve framing 450. Snap-fit projections 252 can be pushed through vent 410 and interlocked with corresponding structural supports on inner assembly 230.

Snap-fit projections 262 are mounted in an inner bracket 260 of inner assembly 230. Inner assembly 230 also includes a valve guide assembly 270 and a bracket cover 280. Valve guide assembly includes a valve guide plate 276, a spring base plate 272, and a helical compression spring 274. Snap-fit projections 252 are mounted on an outer bracket 250 of outer assembly 240. Outer bracket 250 forms a seat for blocking member 226 of mask valve 220. The seat surface of outer bracket 250 is angled relative to the direction of fluid flow and is made from a malleable silicone to assist the blocking member 226 in sealing against the outer bracket 250.

Guide plate 276 is shaped to be received in inner bracket 260 in a pair of guide cavities 264 diametrically opposed to one another across a portion of passage D through bracket 260. Guide plate 276 has a center aperture 278 to receive shaft 222 of mask valve 220 in a snap-fit connection with guide plate 276 holding shaft 222 at groove 224 when inner assembly 230 and outer assembly 240 are joined by snap-fit projections 262 and 252. Shaft 222 may be pushed through a portion of passage D in outer bracket 250, through vent 410, through an aperture in center support 452 of valve framing 450, through a central aperture of spring base plate 272, through helical spring 274, and finally through center aperture 278 of guide plate 276. Central aperture 278 is shaped to hold shaft 222. The insertion of shaft 222 through central apertures may assist in stabilizing mask valve 220 as shaft 222 is supported by intervening components.

When mask valve 220 is secured to guide plate 276 the movement of mask valve 220 is limited by the limited range of movement available to guide plate 276. Guide plate 276 is able to move up and down within guide cavities 264, with movement towards vent 410 limited by edges 266 at the base of cavities 264 when inner assembly 230 is assembled. Movement of guide plate 276 away from edges 266 is limited by bracket cover 280 when inner assembly 230 is assembled.

When inner assembly 230 is sealed against inner face 420 of mask substructure 400, spring base plate 272 rests against center support 452 of vent framing 450 and supports helical spring 274 as spring 274 bears against guide plate 276. Spring 274 bears against guide plate 276 to bias guide plate 276 away from vent 410, thereby also drawing mask valve 220 towards vent 410. When drawn towards vent 410, mask valve 220 seats against outer bracket 250 around a periphery of blocking member 226 to block fluid flow through outer bracket 250.

Referring to FlGS. 8A and 8B, hose connector member 300 is depicted in exploded views. Hose connector member 300 includes an elbow extension 330, a valve housing 340, and a valve guide assembly 350. Like valve guide assembly 270 of mask connector member 200, valve guide assembly 350 includes a spring base plate 352, a helical spring 354, and a valve guide plate 356. Hose connector member 300 includes hose valve 320 which has a blocking member 326, and a shaft 322 having an annular groove 324.

Guide plate 356 is shaped to be received in housing 340 in a pair of guide cavities 342 diametrically opposed to one another across a portion of passage C through housing 340. Guide plate 356 has a center aperture 358 to receive annular shaft 322 of hose valve 320 in a snap-fit connection with guide plate 356 holding shaft 322 at groove 324, with hose valve 320 separated from guide plate 356 by housing inner frame 348. Post 322 may be pushed through a portion of passage D in housing 340, through an aperture in inner frame 248, through a central aperture of spring base plate 352, through helical spring 354, and finally through center aperture 358 of guide plate 356. Central aperture 358 is shaped to hold shaft 322. The insertion of shaft 322 through central apertures may assist in stabilizing hose valve 320 as shaft 322 is supported by intervening components.

When hose valve 320 is secured to guide plate 356 the movement of hose valve 320 is limited by the limited range of movement available to guide plate 356. Guide plate 356 is able to move up and down within guide cavities 344, with movement towards vent 410 limited by edges 344 at the base of cavities 342. Movement of guide plate 356 away from edges 344 is limited by an inner surface of elbow extension 330 when elbow extension 330 is joined to housing 340 of hose connector member 300.

Elbow extension 330 is joined to housing 340 of hose connector member 300 and held in place by adhesive to provide an enclosed and non-linear passage C through hose connector member 300. In some embodiments, an elbow extension may be held in place on a housing other than by adhesive, such as by way of mechanical fasteners. Elbow extension 330 includes a backstop member 332 and a sealing wall extension 334 to enclose passage C through hose connector member. Elbow extension 330 also forms a fluid line projection 336 on which a fluid line (not shown) can be mounted to allow inlet 312 to receive a fluid flow from the fluid line.

When hose connector member 300 is assembled, spring base plate 352 rests against an inner surface of inner frame 348 of housing 340 and supports spring 354 as spring 354 bears against guide plate 356. Spring 354 bears against guide plate 356 to bias guide plate 356 away from inner frame 348, thereby also drawing hose valve 320 towards inner frame 348. When drawn towards inner frame 348, hose valve 320 seats against housing 340 around a periphery of blocking member 326 to block fluid flow through housing 340. The seat surface of housing 340 is angled relative to the direction of fluid flow and is made from a malleable silicone to assist the blocking member 326 in sealing against the housing 340.

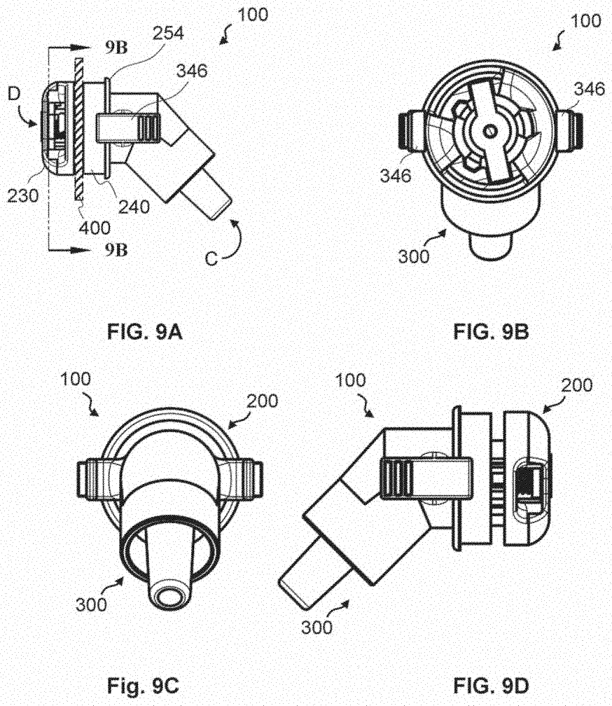

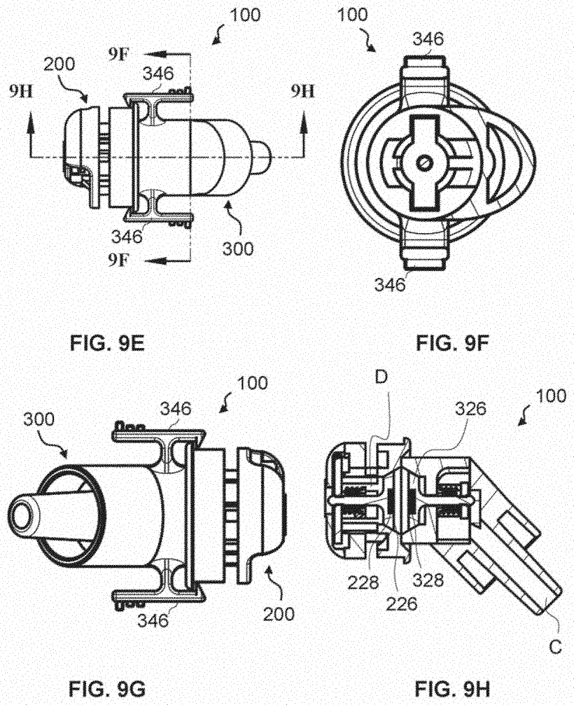

Referring to FIGS. 9A to 9H, connector apparatus 100 is shown with inner assembly 230 and outer assembly 240 joined together. Mask connector member 200 is shown with mask substructure 400 received between inner assembly 230 and outer assembly 240 in FIG. 9A, but without a mask or mask substructure received between inner assembly 230 and outer assembly 240 in FIGS. 9B to 9H.

Mask connector member 200 and hose connector member 300 are shown coupled to one another to form a sealed connection between mask outlet 314 and external inlet 212. Mask connector member 200 and hose connector member 300 are coupled by way of projections 346 snap-fitted to flange 254 of outer bracket 250. As shown, blocking members 226 and 326 block passages D and C, respectively. In some embodiments, projections 346 may be omitted or may be supplemented or replaced by alternative snap on members that may be released by a mechanical action.

However, when a sealed connection between mask outlet 314 and external inset 212 valves 220 and 320 must be moved to actuated positions to allow a flow of fluid through connector apparatus 100.

Referring to FlGS. 10A to 10D, when a magnet 228 is secured to mask valve 220 and a magnet 328 is secured to hose valve 320, magnets 228 and 328 are arranged to be attracted to one another when mask connector member 200 and hose connector member 300 are coupled to one another. The attraction of magnets 228 and 328 to one another overcomes biasing forces generated by compression springs 274 and 354 and thereby causes valves 220 and 320 to move from rest positions shown in FlGS. 10A and 10B to actuated positions shown in FlGS. 10C and 10D. When valves 220 and 320 are in actuated positions as shown in FIGS. 10C and 10D, passages C and D are open through mask connector member 200 and hose connector member 300.

Valves 220 and 320 open when mask connector member 200 and hose connector member 300 are coupled to one another to allow fluid to flow from a hose affixed to hose connector member 300 through vent 410. For example, a fluid flow may be an oxygen enriched air flow from an oxygen source such as an oxygen concentrator or an oxygen tank or other reserve.

When magnet 228 is mounted on mask valve 220, mask valve 220 of mask connector member 200 is an actuator of hose valve 320. When magnet 328 is mounted on hose valve 320, hose valve 320 of hose connector member 300 is an actuator of mask valve 220. In some embodiments, magnets such as magnets 228 and 328 are embedded, rather than mounted to a surface, and are covered by at least a thin layer of plastic.

Valves 220 and 320 close when mask connector member 200 and hose connector member 300 are removed from one another, since the magnetic attraction between magnets 228 and 328 is reduced to the point where it is not able to overcome the biasing forces generated by compression springs 274 and 354. Closing of passages C and D prevents, respectively, entrance of unfiltered air through open vent 410 and loss of fluid from a hose affixed to hose connector member 300.

Referring to FlGS. 11A to 11F, an alternate embodiment of mask connector member 200 is shown, in which valve guide assembly 270 is replaced by leaf compression spring 290. Center aperture 278′ is found in leaf spring 290 rather than guide plate 276. Like guide plate 276, leaf spring 290 is shaped to be received in an outer bracket 260′ in a pair of guide cavities 264′. Leaf spring 290 provides a biasing force to hold mask valve 220′ against outer bracket 240′.

In another alternate embodiment in which no helical spring and spring base plate are needed, a guide plate, such as guide plate 276, is magnetized and a bracket cover, such as bracket cover 280, is a metal to which the guide plate is attracted.

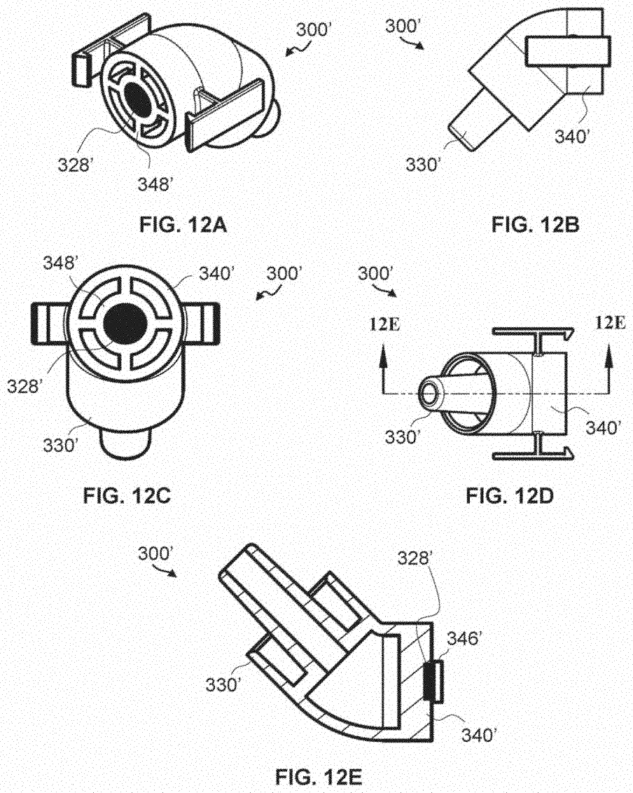

Referring to FIGS. 12A to 12E, an alternate embodiment of hose connector member 300 is shown, which does not include a valve. Hose connector member 300′ is similar to hose connector member 300 but with hose valve 320 and valve guide assembly 350 removed. Further, elbow 330′ and housing 340′, corresponding to elbow 330 and housing 340, are formed integrally. Magnet 328′ is secured to inner frame 248′.

In some embodiments, both magnets 228 and 328 are permanent magnets. However, in some embodiments only one of mask connector member 200 and hose connector member 300 includes a permanent magnet, for example one of mask connector member 200 and hose connector member 300 may include a magnetic element such as a piece of ferromagnetic metal.

In some embodiments, neither mask connector member 200 nor hose connector member 300 includes a magnet, and mask valve 220 is instead moved to an actuated position by a mechanical actuator of hose connector member 300 and/or hose valve 320 is moved to an actuated position by a mechanical actuator of mask connector member 200. For example, bringing hose connector member 300 may cause a protrusion on mask connector member 200 to push against hose valve 320 to actuate hose valve 320 into an actuated position using kinetic energy.

In some embodiments, mechanical connections, such as projections 346, 252, or 262, are replaced or augmented by one or more of an alternative snap-fit connection, a threaded connection, a latch connection, a magnetic connection, and a keyhole tack connection.

In some embodiments, mechanical connections, such as projections 346, 252, or 262, are not included. For example, the connection between an actuator of a hose connector member and a valve of a mask connector member may be relied upon to hold the hose connector member and mask connector member together, such as where the connection between an actuator and a valve is a strong magnetic connection. In another example, the snap-fit connection between snap-fit member 222 and guide plate 276 may be relied upon to hold inner assembly 230 and outer assembly 240 together without projections 252 and 262 in some embodiments.

In the embodiments depicted in the drawings, a connector apparatus is provided to retrofit an existing vent to one which can be used with a fluid line. However, in some embodiments, a connector apparatus is integrated into a mask natively. For example, while example connector apparatus 100 is mounted by way of projections and a valve shaft passing through vent 410, a connector mask may instead be secured to a mask integrally rather than mounted on the mask.

In some embodiments, the connector apparatus 100 is configured for use with water or other liquids. In some embodiments, oxygen supply system 80 is also configured for use with water or other liquids rather than an air supply from supply 700. For example, in some embodiments a connector apparatus includes a straw extending from mask connector member 200 beneath mask 500 and coupled to the internal outlet 214 of the mask connector so that a user can draw liquid into their mouth.

In some embodiments, a connector apparatus may be used with a vent other than a mask vent. For example, a connector apparatus of the present disclosure may be configured to join a fluid supply such as an oxygen tank to a hose or may be configured to join two hoses together. In some embodiments, a connector apparatus of the present disclosure may be used with a non-filter face mask, such as a face mask which is provided to block all ingress of air other than air flow through a connector apparatus of the present disclosure or a face mask which provides for ingress of unfiltered air in addition to air supplied through a connector apparatus of the present disclosure.

The present invention has been described here by way of example only. Various modification and variations may be made to these exemplary embodiments without departing from the scope of the invention, which is limited only by the appended claims.

1. A connector apparatus comprising:
a mask connector member to be secured to a mask to govern fluid flow through a vent in the mask, the mask connector member forming a mask fluid flow passage through the vent between an external inlet and an internal outlet, the mask connector member including a mask valve received in the mask fluid flow passage, the mask valve movable between a rest position in which the mask fluid flow passage is blocked by the mask valve and an actuated position in which the mask fluid flow passage is unblocked by the mask valve, the mask connector member further including a biasing member biasing the mask valve towards the rest position; and
a hose connector member to be secured to a fluid hose, the hose connector member forming a hose fluid flow passage between a hose inlet and a mask outlet, the hose inlet shaped to receive a fluid flow from the fluid hose when the fluid hose is secured to the hose connector member, the mask outlet shaped to form a sealed connection with the external inlet of the mask connector member to supply the fluid flow to the external inlet of the mask connector member when the hose connector member is coupled to the mask connector member, the hose connector member including a valve actuator to move the mask valve to the actuated position when the hose connector member is coupled to the mask connector member.

2. The connector apparatus of claim 1, wherein the mask valve includes a first magnetic element and the valve actuator includes a second magnetic element configured to attract the first magnetic element to draw the mask valve from the rest position to the actuated position.

3. The connector apparatus of claim 2, wherein the mask connector includes:
an inner assembly to seal against an inner surface of the face mask around an inner periphery of the vent; and
an outer assembly to seal against an outer surface of the face mask around an outer periphery of the vent;
the inner assembly and the outer assembly releasably connectable through the vent to form the mask fluid flow passage through the vent.

4. The connector apparatus of claim 3, wherein the second magnetic element is secured to a hose valve, the hose valve received in the hose fluid flow passage and movable between a rest position in which the hose fluid flow passage is blocked by the hose valve and an actuated position m which the hose fluid flow passage is unblocked by the hose valve, the hose valve configured to be drawn toward the actuated position when adjacent the mask valve by the first magnetic element.

5. The connector apparatus of claim 3, wherein the mask connector member includes a first mechanical coupling element and the hose connector member includes a second mechanical coupling element, the first and second mechanical coupling elements configured to releaseably couple the hose connector member to the mask connector member.

6. The connector apparatus of claim 2, wherein the hose fluid flow passage is a non-linear passage.

7. The connector apparatus of claim 2, wherein the mask valve is a disc valve.

8. The connector apparatus of claim 1, wherein the biasing member is a compression spring.

9. A respiratory system, comprising:
an oxygen supply;
a respiratory mask having a vent therethrough;
a mask connector member secured to the respiratory mask to govern fluid flow through the vent, the mask connector member having a valve moveable between a rest position blocking fluid flow through the vent and an actuated position unblocking fluid flow through the vent, the valve biased towards the rest position;
a hose having first and second ends and coupled to the oxygen supply at the first end to receive the flow cf air from the oxygen supply; and
a hose connector member coupled to the hose at the second end to receive the flow of air from the hose, the hose connector member shaped to be coupled to the mask connector member to drive the valve to the actuated position and to supply the fluid flow to pass through the vent.

10. The respiratory system of claim 9, wherein the mask includes an exhalation opening governed by a one-way valve.

11. The respiratory system of claim 9, wherein the mask is a filter mask to allow a user to breathe filtered air through the mask when the hose connector member is not coupled to the mask connector member.

12. The respiratory system of claim 9, wherein the oxygen supply is an oxygen concentrator.
